(19) United States
(12) Patent Application Publication
(10) Pub. No.: US 2016/0117118 A1
(43) Pub. Date: Apr. 28, 2016

(54) SYSTEM AND METHODS FOR PROCESSOR-BASED MEMORY SCHEDULING

(71) Applicant: CORNELL UNIVERSITY, Ithaca, NY (US)

(72) Inventors: José F. MARTÍNEZ, Ithaca, NY (US); Saugata GHOSE, Pittsburgh, PA (US)

(21) Appl. No.: 14/898,555

(22) PCT Filed: Jun. 20, 2014
(86) PCT No.: PCT/US14/43381

§ 371 Date: Dec. 15, 2015

Related U.S. Application Data
(60) Provisional application No. 61/837,292, filed on Jun. 20, 2013.

(51) Int. Cl. G06F 3/06; G06F 13/16

(52) U.S. Cl. CPC G06F 3/0611; G06F 13/1657; G06F 13/1673; G06F 13/1689; G06F 3/065; G06F 3/0619; G06F 3/0673; G06F 3/0653; G06F 3/0659

(57) ABSTRACT

The invention relates to a system and methods for memory scheduling performed by a processor using a characterization logic and a memory scheduler. The processor influences the order by which memory requests are serviced and provides associated hints to the memory scheduler, where scheduling actually takes place.

This Application claims the benefit of U.S. Provisional Patent Application Ser. No. 61/837,292 filed Jun. 20, 2013.

### GOVERNMENT FUNDING

The invention described herein was made with government support under grant number CCF0545995 and CNS0720773, awarded by the National Science Foundation (NSF). The United States Government has certain rights in the invention.

### FIELD OF THE INVENTION

The invention relates generally to computer architecture. More specifically, the invention relates to a system and methods for memory scheduling assisted by a processor. The processor influences the order by which memory requests are serviced, and provides hints to the memory scheduler, where scheduling actually takes place.

### BACKGROUND OF THE INVENTION

The processor (CPU) and memory subsystem of a computer system typically operate in a decoupled fashion. When the processor needs to load data from memory, it dispatches a load request containing the memory address. If this request isn't found inside local caches (which store the most recently used data), the request is sent downstream to the Dynamic Random-Access Memory (DRAM). This is called a cache miss. As these DRAM requests can take a long time, there are often several of these requests queued up waiting to be serviced at any given time.

Since memory is commonly a shared resource for a computer system, many memory requests run concurrently. Concurrently running memory requests have different access behaviors and compete for memory resources. Memory scheduling algorithms are typically designed to arbitrate memory requests, provide high system throughput, and exemplify fairness.

Memory scheduling is an area of research that has gained importance in the last decade. Memory scheduling tries to optimize a target objective for a running program (e.g., faster execution, better energy efficiency, etc.) by choosing the order by which memory requests are serviced. Due to the fact that schedule optimization is an inherently hard problem, and that various timing constraints and idiosyncrasies exist inside the memory subsystem, successful memory schedulers can be complex.

Traditional DRAM memory scheduling only uses information directly observable by the memory scheduler to determine the order in which requested addresses should be serviced.

One known memory scheduler referred to as the First-Ready, First-Come First-Serve (FR-FCFS) memory scheduler aims to reduce the amount of work done inside the scheduler. The FR-FCFS memory scheduler reorders memory requests to the memory subsystem. More specifically, the FR-FCFS memory scheduler classifies each of the plurality of memory requests into subsets, based on whether the request will access a row of memory within the memory subsystem that has already been opened. Inside each of these subsets, the plurality of memory requests are then individually prioritized based on the time for which they have been pending completion. The scheduler then chooses one or more requests with the highest prioritization to issue to the memory subsystem.

Another known memory scheduler uses an observed characteristic for classification of the one or more memory requests. Specifically, the observed characteristic according to this known memory scheduler is the position of each of the plurality of memory instructions within the instruction reorder buffer at the time each of the plurality of memory instructions are issued by the processor. No classification information is saved, but information is annotated to each memory request, and updated within the memory scheduler once the request arrives at the scheduler. Logic exists within the scheduler to perform this update, estimating the distance from the head of the instruction reorder buffer at request arrival time for the memory instruction corresponding to the memory request. The memory scheduler uses this updated annotation (hint) to sort and store the requests in ascending order.

When request classification is required, the requests are classified into two subsets. Requests that are less than a certain threshold distance from the head of the instruction reorder buffer are placed in the prioritized subset of requests. Requests from the prioritized subset can be sent to the memory subsystem for processing. Requests in the unprioritized subset have their annotated distance reduced by the amount of the threshold distance. Request classification of pending memory requests is only performed when the prioritized subset no longer contains any memory requests.

This memory scheduler that uses an observed characteristic has limited applicability. It can only classify memory requests based on the distance of their corresponding memory instructions to the head of the instruction reorder buffer, it can only classify the requests into two groups, and does not allow for the use of other classifications or classification granularities. For example, the memory schedule cannot take past behavior of the corresponding memory instructions into account. It is also unable to make decisions based on a sequence of historical observations. There is no effective mechanism in this design to observe memory instruction classifications that pertain to the overall processor environment. As such, the applications of this memory scheduler are limited in scope.

Other known memory schedulers include adaptive history-based memory schedulers which track the history of previous requests to predict how long new requests will take and prioritizing the fastest of those, the Thread Cluster Memory scheduler and the Minimalist Open-page scheduler which rank memory requests based on prioritizing the program thread that created the request, as well as memory schedulers that use priorities generated inside the memory controller to re-order memory requests in order to enforce system intentions. A few known schedulers infer information from inside the core. However, the inferences are performed inside the memory scheduler adding to the scheduler's complexity.

A very large body of work in the field of computer architecture has been devoted to processor-based predictors. These predictors include a criticality predictor that predicts how sensitive loads are to delays and places them in faster cache levels, a token-based criticality predictor that tries to predict the critical path of latency through a series of instructions in a program, and a load criticality predictor that tracks the number of instructions dependent on a load instruction, and predicts that loads with more dependent instructions is more likely to be critical. Few of these deal solely with loads, and some fail to use this information to assist memory scheduling. Instead, predictor-based optimizations are performed inside the processor. However, none of these predictors passes information directly to the memory scheduler.

There is a demand for improved memory scheduling for sharing system resources effectively, including achieving a target quality of service, while providing an expanded throughput, increased latency, fairness (CPU time for each process based on priority and workload), and decreased waiting time. The invention satisfies this demand.

### SUMMARY OF THE INVENTION

The invention is directed to a system and methods for processor-based memory scheduling that provides for a much more robust mechanism within a processor, which can use a wide range of characterization logic to either determine or predict the class to assign to a memory instruction and its corresponding memory requests.

It is contemplated that the system and methods according to the invention may be integrated into an arbitrary type of memory scheduler. The large choice of characterization logic and memory scheduler type allows the invention to target a large number of different optimizations, while delivering improvements over a much wider range of memory subsystems.

In one embodiment, the system and methods for memory scheduling according to the invention comprises one or more processors for issuing memory requests, each memory request corresponding to a memory instruction that is also processed by the one or more processors. A characterization logic monitors the memory instructions and conducts a classification for each memory instruction. The classification for each memory instruction includes a discrete number of classes. The classification for each memory instruction may further be based on a relative urgency of processing by the memory subsystem the memory requests. The characterization logic annotates each memory request to include one or more annotations concerning the classification for each memory instruction. A memory scheduler determines a time and an order for processing the memory requests by the memory subsystem based partially on the classification, and sends the memory requests to the memory subsystem according to the time and the order. The memory subsystem then processes the memory requests.

In another embodiment, the system and methods may further include a hardware storage for saving information related to the classification conducted by the characterization logic. This information may further be used to assist the characterization logic, for example with monitoring the memory instructions, conducting a classification for the memory instructions, or providing annotations concerning the classification for each memory instruction.

In another embodiment, the system and methods may further include an instruction reorder buffer. The classification for each memory instruction may include a frequency or an amount of time by which each memory instruction remains at a head of the instruction reorder buffer.

A combination of characterization logic and memory scheduling allows the pre-processing of scheduling information, simplifying the scheduling decision inside the memory subsystem. The combination also targets application performance of the processor as opposed to memory in order to optimize overall program behavior.

The characterization logic identifies loading memory instructions previously executed by a processor as well as information regarding the loading memory instructions position at the head of instruction reorder buffer. Memory scheduling includes choosing one or more of the pending memory requests to send to the memory subsystem.

Characterization logic includes binary prediction of memory instructions that remain at the head of the instruction reorder buffer at least once or during their last execution. Characterization logic also includes prediction of the greatest amount of time, most recent amount of time, total accumulated amount of time, or frequency of which each memory instruction remains at the head of the instruction reorder buffer. Yet characterization logic may also include prediction of memory instructions remaining at the head of the reorder buffer or memory operation buffer that cause the buffers to temporarily fill to capacity. Furthermore, characterization logic may include prediction (with or without speculation) of a pattern for when memory instructions remain at the head of the reorder buffer. Characterization logic also includes prediction of memory operations that fall along the critical path of program execution and prediction of urgent memory operations using online statistical analysis.

The memory scheduler according to the invention includes a scheduler with annotation-based prioritization. For example, the memory scheduler may be any of the following schedulers with annotation-based prioritization: a first-come first-serve scheduler, a first-ready, first-come first-serve scheduler, a reinforcement learning based scheduler, or a round-robin arbiter scheduler.

The invention and its attributes and advantages may be further understood and appreciated with reference to the detailed description below of contemplated embodiments, taken in conjunction with the accompanying drawings.

### DESCRIPTION OF THE DRAWING

The accompanying drawings, which are incorporated in and constitute a part of this specification, illustrate an implementation of the invention and, together with the description, serve to explain the advantages and principles of the invention:

FIG. 1 illustrates a block diagram of an exemplary system for processor-based memory scheduling according to one embodiment of the invention.

FIG. 2 illustrates a block diagram of an exemplary system for predicting the critical behavior of load instructions of a reorder buffer according to one embodiment of the invention.

FIG. 3 illustrates a flowchart of an exemplary characterization logic that predicts the critical behavior of load instructions of a reorder buffer according to one embodiment of the invention.

FIG. 4 illustrates a block diagram of an exemplary system for predicting the magnitude of criticality for a load instruction according to one embodiment of the invention.

FIG. 5 illustrates a flowchart of an exemplary characterization logic that predicts the magnitude of criticality for a load instruction according to one embodiment of the invention.

FIG. 6 illustrates a flowchart of an exemplary system that uses annotated prediction within a memory request according to one embodiment of the invention.

### DETAILED DESCRIPTION OF THE INVENTION

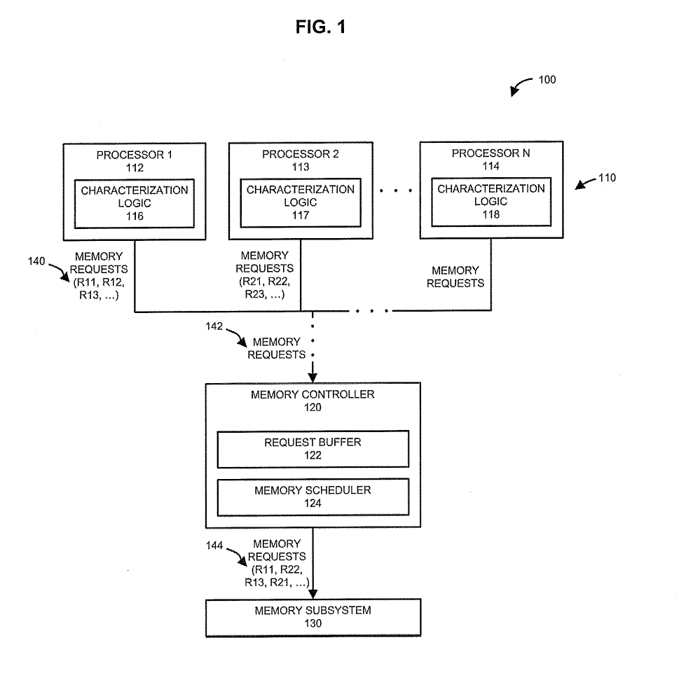

FIG. 1 is a simplified block diagram of an exemplary system implementing memory scheduling, according to one embodiment of the invention. The memory scheduling system 100 includes the at least one processor 110—shown specifically in FIG. 1 as processors 112, 113, and 114—, at least one memory controller 120, and the at least one memory subsystem 130. The at least one processor 110 makes a plurality of memory requests 140—shown specifically in FIG. 1 as requests R11, R12, and R13 made by processor 112 and requests R21, R22, and R23 made by processor 113. The memory controller 120 receives a plurality of memory requests 142, each corresponding to at least one of the memory requests 140. The at least one processor 110 may optionally contain one or more local caches which contain a subset of memory locations. If the location desired by a memory request is found within these local caches, the request completes without reaching the memory controller 120. The memory controller 120 determines the order in and time at which these requests are to be sent to the memory subsystem 130. Within the memory controller 120 are the request buffer 122, which in at least one embodiment stores the incoming memory requests 142, and the memory scheduler 124, which examines the requests within the request buffer 122 to determine which request, if any, to send during the next scheduling interval to the memory subsystem 130. In at least one embodiment, the memory system 130 consists of an organization of DRAM devices.

Within the system 100, a processor 110 generates a memory request 140 that corresponds to an instruction within the at least one program currently being executed by the processor 110. In at least one embodiment, the processors 112, 113, and 114 each contain characterization logic 116, 117, and 118. Before a memory request 140 leaves the processor, the characterization logic 116, 117, and 118 is used to annotate the memory request 140 with a classification, discussed more fully below. This annotation is sent as part of the memory request 140 out of the processor 110. In some embodiments, each of the memory requests 140 sent by the processor 110 are the same memory requests 142 received by the memory controller 130, while in other embodiments, each of the memory requests 142 correspond to one or more of the memory requests 140 sent by the processor 110, but in all cases, the memory requests 142 contain the same annotations as their corresponding memory requests 140.

In at least one embodiment, the request buffer 122 in the at least one memory controller 120 holds a plurality of entries, with each entry corresponding to an incoming memory request 142, and with each entry containing the annotation that was sent along with the memory request 142. At each scheduling interval, a memory scheduler 124 uses the annotation stored within each entry of the request buffer 122 to assist in determining if at least one of these requests should be sent to the memory subsystem 136 as the next memory request 144.

The characterization logic first identifies loading memory instructions, where the memory instruction (uniquely identified by its program counter address) was previously executed within the at least one processor, and during at least one of these previous executions, the loading memory instruction remained at the head of the instruction reorder buffer for at least one processor clock cycle. Detecting that a memory instruction remains at the head of the instruction reorder buffer requires two pieces of logic: hardware to recognize that the instruction is for loading memory, and hardware to recognize that the instruction currently at the head of the instruction reorder buffer is the same one that was there in the previous processor clock cycle. A loading memory instruction can be recognized by reading one or more of the status bits generated within the decoder of the at least one processor. In order to recognize the instruction remaining at the head of the instruction reorder buffer, a hardware buffer stores the instruction reorder buffer sequence number of the instruction that was at the head in the previous cycle. If this sequence number is the same as the instruction currently at the head of the instruction reorder buffer, then the instruction did in fact remain there for at least one cycle.

This prediction requires hardware storage to remember which loading memory instructions previously remained at the head of the instruction reorder buffer. A portion of the program counter address of a loading memory instruction is used to index a storage table. If a loading memory instruction is observed by the logic described above to remain at the head of the instruction reorder buffer, this is recorded in the storage table. In this embodiment, nothing is done if the loading memory instruction does not remain at the head of the instruction reorder buffer.

Optionally, this storage table can store the remaining portion of the program counter address, for example the parts not used to index the storage table referred to as “a tag”. Also optionally, the storage table can be reset after a certain interval. This optional reset can either be performed on the entire table or per individual entry/groups of entries. For example, after counting down a number of events, all of the records are cleared or each entry/group has an individual counter that is used to determine at what time that entry/group should be reset.

When the at least one processor handles a new instance of a loading memory instruction, it indexes the entry in the storage table corresponding to that instruction's program counter address. If the storage table has previously recorded this entry as remaining at the head of the instruction reorder buffer, the loading memory instruction is annotated as critical; otherwise, the instruction is annotated as non-critical—if the storage table optionally contains tags as aforementioned, then the priority is only marked if the tag stored in the storage table matches that of the instruction being handled. This annotation is a prediction of whether this new instance is critical or non-critical. When the at least one processor is ready to issue a memory request corresponding to this loading memory instruction, this annotation is sent alongside the address of the information that must be retrieved from memory.

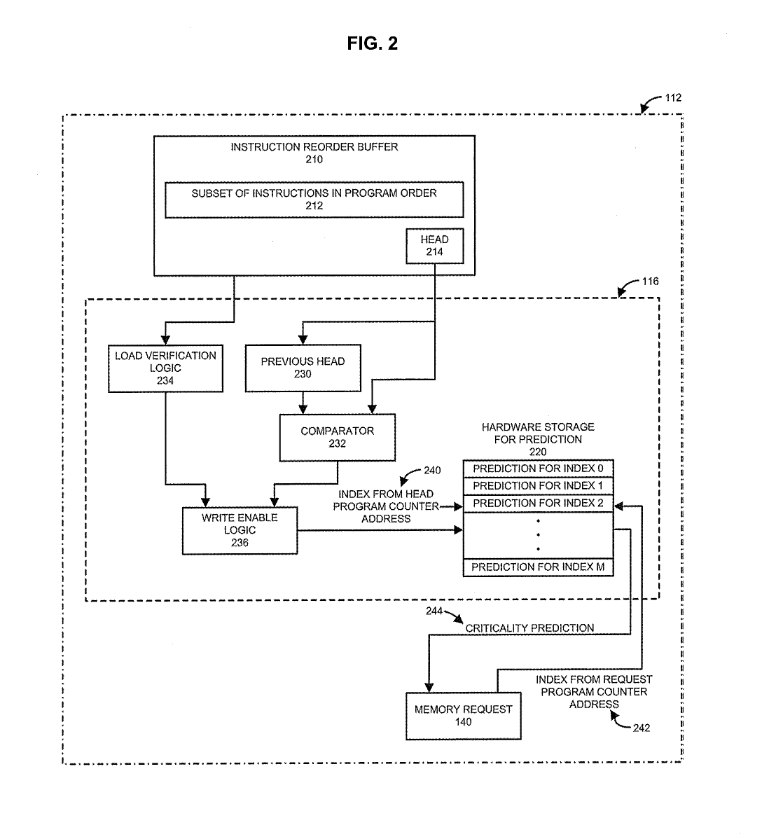

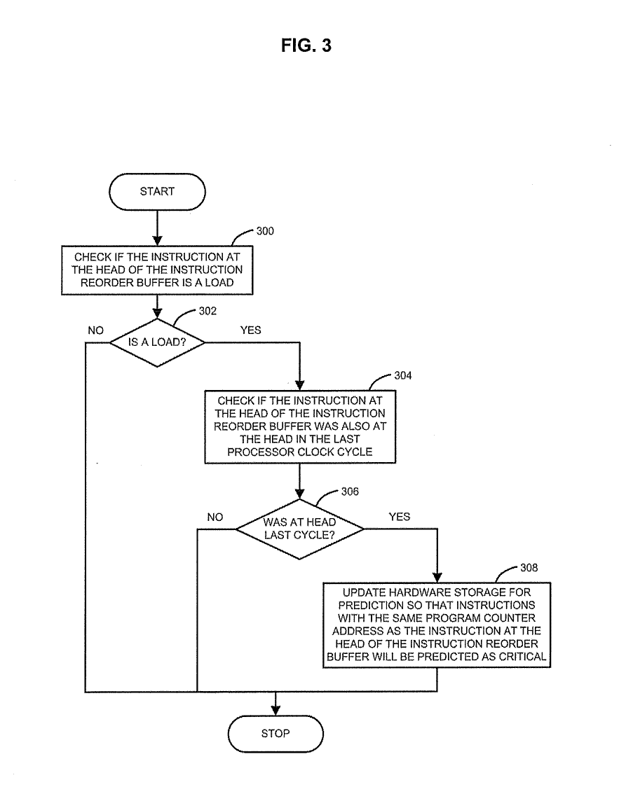

FIG. 2 illustrates a block diagram of an exemplary system and FIG. 3 illustrates a flowchart of an exemplary characterization logic for prediction whether load instructions remain at the head of the instruction reorder buffer.

At least one embodiment of the characterization logic 116 (which has the same design as the characterization logic 117 and 118 used in processors 113 and 114) is illustrated in FIG. 2. This particular characterization logic 116 monitors load instructions that are a part of the at least one program being executed by the processor 112. The processor 112 (as well as all processors 110) contains some form of instruction reorder buffer 210, which is defined to contain a storage element 212 that holds a list of a subset of instructions from the at least one program being executed by the processor 112. This subset of instructions is stored in program order and each element of this subset can be uniquely identified with a sequence number. In at least one embodiment of this instruction reorder buffer 210, the storage element includes a buffer that contains the sequence number of the oldest instruction within the subset (i.e., the buffer head 214). This particular characterization logic 116 also requires a hardware storage 220, which in at least one embodiment contains a prediction of whether a load is critical (i.e., should be prioritized by the memory scheduler 124) and is indexed using a fixed subset of bits from the program counter such that for each entry of the hardware storage 220, there is a unique program counter subset that corresponds to it (i.e., the index). Each entry of the hardware storage 220 is initialized to false. The table only stores whether the prediction is true or false, and in at least one embodiment, each entry consists of a single bit.

This instance of the characterization logic 116 behaves as shown in FIG. 3. At 300, the characterization logic first checks whether the instruction at the head 214 of the instruction reorder buffer 210 is an instruction that is trying to load data from memory (which may consist of a hierarchy of memory subsystems according to one embodiment of the invention). If this instruction is a load, flow is from 302 to 304 to check if the instruction at the head 214 of the instruction reorder buffer 210 is the same as the one that was there at the last processor clock cycle. If the instruction is the same, flow is from 306 to 308, where the load is marked as critical in the prediction table 220.

In order to implement the behavior shown in FIG. 3 for this instance of the characterization logic 116, a number of hardware elements are added, as shown in FIG. 2. A previous head buffer 230 contains the sequence number of the instruction that was at the head 214 of the instruction reorder buffer 210 in the previous clock cycle of processor 112. A comparator 232 determines whether the value in the previous head buffer 230 is identical to the value in the current head 214, outputting true if it is and false if it is not. The load verification hardware 234 uses status bits from the instruction at the head 214 of the instruction reorder buffer 210 to determine if that instruction is a loading memory instruction, outputting true if it is and false if it is not. The output of the comparator 232 and the load verification, hardware 234 is then combined in the write enable logic 236, which only allow an entry within the hardware storage 220 to be updated when both of these outputs are true. When the write enable logic 236 allows the update, this embodiment of the characterization logic uses the program counter address 240 for the instruction at the head 214 of the instruction reorder buffer 210 to index the hardware storage 220, and sets the value within the entry corresponding to the index to be true.

In this embodiment, before a memory request 140 is sent by the processor 112 to retrieve data for a loading memory instruction, the program counter address of that instruction 242 is used to index the hardware storage 220. The prediction 244 stored within the entry corresponding to the index is read from the hardware storage 220, and is added as part of the memory request 140. This entry contains a prediction of whether this memory request 140 is critical, which can be represented using a single bit. When sent to memory, the memory request 140 includes this prediction, as well as the address of the portion of memory that has been requested by the loading memory instruction.

In the embodiments described above, the loading memory instruction did not remain at the head of the instruction reorder buffer such that no change was made to the hardware storage table. However, it is contemplated that if a loading memory instruction does not remain at the head of the instruction reorder buffer, this may also be recorded in the storage table. Thus, the most recently observed behavior of the loading memory instruction for annotation is recorded, while the embodiment discussed above annotates a loading memory instruction as critical if any of its prior instances—including after the last reset if the optional reset logic is used—remained at the head of the instruction reorder buffer.

It is also contemplated that the storage table may record how many instances remained at the head of the instruction reorder buffer. In order to do this, the characterization logic must store whether the instruction at the head of the instruction reorder buffer in the previous processor clock cycle remained at the head the clock cycle beforehand. Along with this, the table index—and tag if optional storage table tagging is used—portions of the program counter address for this instruction must be stored in a hardware buffer. If the instruction previously at the head of the instruction reorder buffer was a loading memory instruction that was detected to have been remaining, and is no longer at the head of the instruction reorder buffer, then the entry in the storage table is incremented. Optionally, for instances of the loading memory instruction that do not remain at the head of the instruction reorder buffer, the entry in the storage table can be decremented. Furthermore, the entry can be designed as a saturating counter, where it has a fixed maximum and minimum bound between which the value must fall within. When the at least one processor handles a new instance of a loading memory instruction and looks up the prediction in the storage table, the value contains a number, for example, a number representing the frequency of memory instructions remaining at the head of the instruction reorder buffer. This value can either be used directly to annotate the loading memory instruction, or can be fit into discrete classifications by some additional logic that translates this frequency to the degree of criticality.

Another embodiment according to the invention may include a storage table that records the longest amount of time that any one instance remained at the head of the instruction reorder buffer. Again, the characterization logic must store whether the instruction at the head of the instruction reorder buffer in the previous processor clock cycle remained at the head the clock cycle beforehand and the table index—and tag if optional storage table tagging is used—portions of the program counter address for this instruction must be stored in a hardware buffer. A counter must also be used, which counts the number of cycles the current instruction has remained at the head of the instruction reorder buffer. According to this embodiment, the counter may be designed as a saturating counter, where it has a fixed maximum and minimum bound between which the value must fall within. If the instruction previously at the head of the instruction reorder buffer was a loading memory instruction that was detected to have been remaining, and is no longer at the head of the instruction reorder buffer, then the entry in the storage table is updated only if the value in the counter is greater than the value stored within the entry already.

When the at least one processor handles a new instance of a loading memory instruction and looks up the prediction in the storage table, the value contains a number representing the longest amount of time that any one instance of a memory instruction remained at the head of the instruction reorder buffer. This value can either be used directly to annotate the loading memory instruction, or can be fit into discrete classifications by some additional logic that translates this frequency to the degree of criticality.

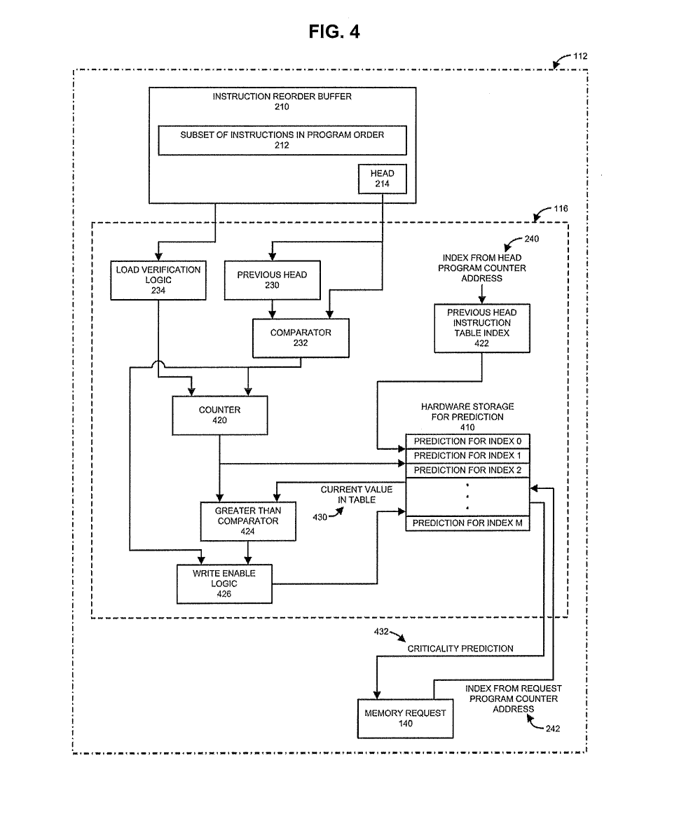

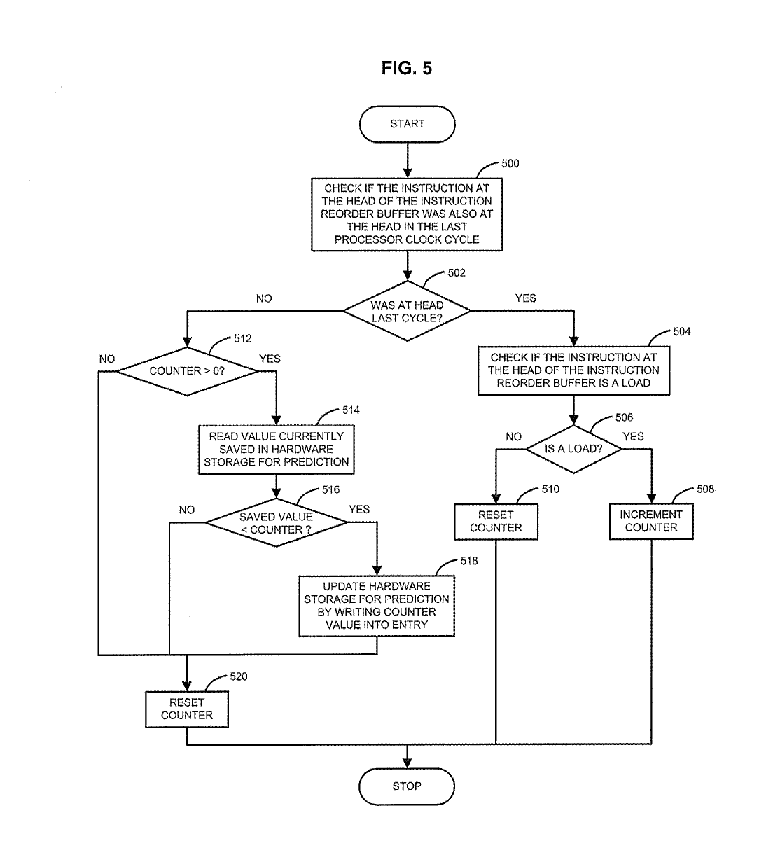

FIG. 4 illustrates a block diagram of an exemplary system and FIG. 5 illustrates a flowchart of an exemplary characterization logic for predicting the magnitude of criticality for a load instruction based on the longest time it remained at the head of the instruction reorder buffer according to one embodiment of the invention.

The characterization logic 116 (similar in design as the characterization logic 117 and 118 used in processors 113 and 114) illustrated in FIG. 4 also monitors load instructions that are a part of the at least one program being executed by the processor 112. As before, the processor 112 (as well as all processors 110) contains some form of instruction reorder buffer 210, which contains a storage element 212 that holds a list of a subset of instructions in program order from the at least one program being executed by the processor 112 where each element of this subset can be uniquely identified with a sequence number. In at least one embodiment of this instruction reorder buffer 210, the storage element includes a head buffer 214 with the sequence number of the oldest instruction in the storage element 212. This particular characterization logic 116 also requires a hardware storage 410, which in at least one embodiment contains a prediction of the magnitude of criticality for a load, and is indexed using a fixed subset of bits from the program counter such that for each entry of the hardware storage 410, there is a unique program counter subset that corresponds to it (i.e., the index). In at least one such embodiment, each entry of the hardware storage 410 stores a binary number, and is initialized to zero.

This instance of the characterization logic 116 behaves as shown in FIG. 5. At 500, the characterization logic first checks whether the instruction at the head 214 of the instruction reorder buffer 210 is the same as the one that was there at the last processor clock cycle. If the instruction is the same, flow is from 502 to 504 to check whether the instruction at the head 214 of the instruction reorder buffer 210 is an instruction that is trying to load data from memory (which in at least one embodiment consists of a hierarchy of memory subsystems). If this instruction is a load, flow is from 506 to 508, at which point a counter (420 in FIG. 4) is incremented. Alternatively, if the instruction is not a load, flow is from 506 to 510, where the counter 420 is reset to zero. Alternatively, if the instruction at the head 214 of the instruction reorder buffer 210 is not the instruction that was there in the previous cycle, flow is from 502 to 512. If the counter 420 is greater than zero, flow is from 512 to 514, where the value currently saved in the hardware storage 410 at the entry for the instruction previously at the head of the instruction reorder buffer 210 is read. If this value is less than the value in the counter, flow is from 516 to 518, where the entry inside the hardware storage 410 is updated with the value currently in the counter 420. Afterwards, flow is from 518 to 520, where the counter 420 is reset to zero. Alternatively, if the current entry value is greater than or equal to the value in the counter 420, flow is from 516 to 520, where the counter 420 is reset to zero. Alternatively, if the counter 420 is not greater than zero, flow is from 512 to 520, where the counter 420 is reset to zero.

In order to implement the behavior shown in FIG. 5 for this instance of the characterization logic 116, a number of hardware elements are added, as shown in FIG. 4. A previous head buffer 230 contains the sequence number of the instruction that was at the head 214 of the instruction reorder buffer 210 in the previous clock cycle of processor 112. A comparator 232 determines whether the value in the previous head buffer 230 is identical to the value in the current head 214, outputting true if it is and false if it is not. The load verification hardware 234 uses status bits from the instruction at the head 214 of the instruction reorder buffer 210 to determine if that instruction is a loading memory instruction, outputting true if it is and false if it is not. The output of the comparator 232 and the load verification hardware 234 is then combined to determine whether the counter 420 should be incremented or reset to zero. The counter 420 may only be incremented when both of these outputs are true, and may otherwise be reset to zero. Every processor cycle, the index 240 (a subset of the program counter address) for the instruction at the head 214 of the instruction reorder buffer 210 is saved in a buffer 422, which results in the buffer 422 holding the index for the instruction that was at the head 214 of the instruction reorder buffer 210 in the previous processor clock cycle. The previous head index buffer 422 is used to index the hardware storage 410 for updating. The hardware storage 410 outputs the current value 430 stored in the entry for the buffered index 422. The current value 430 is checked against the value in the counter 420 using a greater than comparator 424, which outputs true if the value in the counter 420, is greater. This output is combined with the output of the comparator 232 in the write enable logic 426, which enables updates to the hardware storage 410 only when the output of the comparator 232 is false (to ensure that the instruction being counted is no longer at the head 214) and when the output of the greater than comparator 424 is true. When hardware storage updates are enabled, the value inside the counter 420 is written to the hardware storage 410 for the entry at the buffered index 422.

In this embodiment, before a memory request 140 is sent by the processor 112 to retrieve data for a loading memory instruction, the program counter address of that instruction 242 is used to index the hardware storage 220. The prediction 432 stored within the entry corresponding to the index is read from the hardware storage 220, and is added as part of the memory request 140. This entry contains a prediction of how critical this memory request 140 is, as represented using a binary number. When sent to memory, the memory request 140 includes this prediction, as well as the address of the portion of memory that has been requested by the loading memory instruction.

In at least one embodiment, when a memory request 142 is received by the at least one memory controller 120, it is added to a request buffer 122. In at least one embodiment, the memory controller 120 controls a Double Data Rate Synchronous Dynamic Random-Access Memory (DDR DRAM) memory subsystem 130. Such a memory subsystem contains at least one bank of DRAM, wherein a DRAM bank consists of several rows of memory. In a DDR DRAM memory subsystem, at least one row of the DRAM bank can be opened, during which the row is stored within the at least one row buffer. A memory request to a DRAM bank corresponds to a location within one row of the bank, and must open (i.e., activate) that row within the at least one row buffer in order to perform an operation in memory. If there is no empty row buffer for the current bank, the request must first close (i.e., precharge) that row before activation, writing back the contents of the row buffer to the DRAM bank.

As discussed above, the hardware storage table may record the longest amount of time that any one instance of a loading memory instruction remained at the head of the instruction reorder buffer. It is also contemplated that the storage table may record the amount of time that the most recent instance remained at the head of the instruction reorder buffer. For this embodiment, if the instruction previously at the head of the instruction reorder buffer was a loading memory instruction that was detected to have been remaining, and is no longer at the head of the instruction reorder buffer, then the entry in the storage table is updated regardless of whether the value in the counter is greater than the value stored within the entry already.

It is also contemplated that the storage table may record the total amount of time that all instances remain at the head of the instruction reorder buffer. For this embodiment, if the instruction previously at the head of the instruction reorder buffer is a loading memory instruction that is detected to have been remaining, and is no longer at the head of the instruction reorder buffer, then the entry in the storage table is updated by adding the value in the counter to the value already saved in the storage table entry. Optionally, this entry can be designed to saturate, where it has a fixed maximum and minimum bound between which the value must fall within.

As mentioned above, the hardware storage table recorded if at least one observed instance of the loading memory instruction remained at the head of the instruction reorder buffer. However, it is also contemplated that the storage table only records the observed instance when the instruction reorder buffer is full. It is also contemplated that the storage table only records the observed instance when a memory operation buffer—for example, a load queue or a load-store queue—within a processor is full. It is also contemplated that the storage table only records the observed instance when both the instruction reorder buffer and the memory operation buffer are full.

Hardware can be used to determine whether or not the buffer—instruction reorder buffer and/or memory operation buffer—is full. The hardware is dependent on the implementation of the buffer within the processor. Typically, the buffer is implemented as a circular buffer, and includes an index pointing to the first element—referred to as the head pointer—and another index pointing to the first empty position in the buffer after the last element—referred to as the tail pointer. If the head pointer and tail pointer both point to the same index, and the buffer is not empty, then the buffer is full. The indices of these two pointers can be compared, and only write to the storage table whenever the indices are equal and the buffer is not empty. In certain embodiments, a counter tracks the number of processor clock cycles that the loading memory instruction spends at the head of the buffer while the buffer is full. It is also contemplated that the counter may also track the amount of time a loading memory instruction spends at the head of the buffer.

In another embodiment, the storage table records a history of the N most recently observed instances of the loading memory instruction. For this embodiment, when the most recent behavior of a loading memory instruction is observed, this most recent observation is shifted into the First-in-First-Out (FIFO) queue stored at the entry of the hardware storage table corresponding to the loading memory instruction, while the oldest observation is shifted out, ensuring that the FIFO maintains N observations at all times. This is akin to a history register of which known embodiments exist, such as those found in two-level adaptive branch prediction mechanisms.

When the expected behavior of a load is being predicted, the FIFO queue within the hardware storage table is retrieved. This will then be used to index a 2^{N} entry table in hardware, where each entry contains a saturating counter indicating the likelihood of whether the next load in the sequence will be critical. If the value of the saturating counter is greater than a threshold, the load will be predicted as critical; otherwise, the load will be predicted as non-critical.

The saturating counter hardware storage table is updated whenever a loading memory instruction commits. If the load remained at the head of the instruction reorder buffer, the value of the saturating counter for the entry indexed by the FIFO queue will be incremented. Otherwise, this value will be decremented. As mentioned above, increments and decrements do not have any effect on a saturating counter if the counter reaches a maximum or minimum value, respectively.

Alternatively, embodiments based on other branch prediction mechanisms may be used, in essence substituting the most recent criticality observation for the observation of whether the most recent branch was taken.

In addition to the hardware storage table contained a FIFO queue that records the history of the last N committed instructions per entry, it is contemplated that each entry of the hardware storage table may contain two FIFO queues. One queue, as before, records the history of the last N committed instructions per entry. The second FIFO queue records the criticality predictions of the last N load instructions issued to memory per entry. This second FIFO queue, tracking predictions at load issue time, is the one used to index the saturating counter table when a prediction is required. The first FIFO queue, tracking commits, may still be used to update the table.

In another embodiment for the characterization logic, each instance of an instruction within the processor is modeled using a series of timestamps. Non-load instructions are modeled using three timestamps: the clock cycle at which the instruction is dispatched (i.e., added to the instruction reorder buffer), the clock cycle at which the instruction finishes using a functional unit for execution (e.g., ALU, multiplier, branch logic) within the processor, and the clock cycle at which the instruction commits (i.e., leaves the instruction reorder buffer). Load instructions track a fourth timestamp in addition to the three aforementioned: the clock cycle at which the data returns from the memory subsystem to the processor. In principle, a series of edges can be used to connect these timestamps together as a directed acyclic graph.

Within the at least one processor, hardware exists to track both these timestamps and the at least one edge that arrives latest to each of these timestamps, and this information is annotated along with the instruction. Edges arriving earlier than the latest arriving edge are ignored. When the instruction reaches the head of the instruction reorder buffer, and is ready to be committed, this information is passed to characterization logic that uses tokens to track long chains of edges through the directed acyclic graph. A plurality of tokens is maintained, and is implanted into some of the instructions as chosen by selection logic, for example, random selection. When implanted, a prediction table index—based on a subset of the program counter address of the instruction—is saved for that token. For each timestamp, a token propagation table contains an entry that stores which tokens have passed through that timestamp node. For each timestamp of the committing instruction, the at least one last arriving edge is used to identify the timestamp from which the edge is arriving from. The token entry for the source timestamp is read, and copied to the destination timestamp such as the one currently being examined. If multiple last arriving edges exist, or if a token was implanted into this timestamp, the token entry for the destination timestamp contains the union of all tokens identified as traveling through the destination timestamp.

Sometime after the token is implanted, the token propagation entry table is checked to see whether the token is still alive, for example, whether any timestamps of the last N instructions have recorded the token as traveling through them. The saved prediction table index for that token is used to index a criticality prediction table. For each entry of this criticality prediction table, there is a saturating counter that is used to predict whether future occurrences of this instruction are critical. If the token is alive, this counter is incremented; otherwise, it is decremented. The token is then recycled such as placed within a free token list, and can be implanted in a subsequent instruction.

When the at least one processor handles a new instance of a loading memory instruction, it indexes the entry in the criticality prediction table corresponding to that instruction's program counter address. If the saturating counter at that prediction table entry exceeds a threshold, the loading memory instruction is annotated (predicted) as critical; otherwise, the instruction is annotated (predicted) as non-critical. When the at least one processor is ready to issue a memory request corresponding to this loading memory instruction, this annotation is sent alongside the address of the information that must be retrieved from memory.

In another embodiment for the characterization logic, a discrete set of predetermined observations and predictions are used to synthesize a prediction, where the synthesis may be modified while the at least one processor is running. It is contemplated that these observations and predictions can be fed into an artificial neural network. The observations and predictions may include information about the current state of the processor (e.g., the number of instructions currently in the instruction reorder buffer, the depth of the function call stack), the current state of the program (e.g., whether the last branch instruction was predicted properly, how many iterations of a loop the program has executed), and observations and predictions about the instruction itself (e.g., how long the instruction waited before being dispatched, the number of other instructions dependent on this one). In addition, a classification logic determines whether an instruction that was committing should have been prioritized as urgent. For example, this could be observing loads that remained at the head of the instruction reorder buffer, or the number of instructions that were unable to execute until the load returned from memory.

When the oldest instruction in the instruction reorder buffer commits (i.e., completes), the observations/predictions recorded for that instruction, along with the output of the classification logic, are used to update the production synthesizing mechanism (e.g., performing back propagation within the artificial neural network based on the classification logic output). Subsequently, when the at least one processor handles a new instance of a loading memory instruction, it sends the observations/predictions for this loading memory instruction to the synthesizing predictor. This synthesizing predictor then determines whether the urgency with which the load should be annotated. For example, the artificial neural network may contain a series of weights that are multiplied to each observation, after which one or more of these weighted observations are summed up; this procedure may be performed in succession one or more times, corresponding to the number of levels contained within the artificial neural network. The value output of the synthesizing predictor may either be used directly to annotate the loading memory instruction, or may be fit into discrete classifications by some additional logic that translates this frequency to the degree of criticality.

It is also contemplated that alternative prediction synthesis mechanisms may include decision trees, k nearest neighbors, reinforcement learning, support vector machines, linear regression, and others.

Optionally, each of the aforementioned embodiments of the characterization logic can be modified to associate the annotation for each of the one or more memory requests based on the characterization of a plurality of memory instructions. In at least one such embodiment, caches that lie between the processor and the at least one memory subsystem will modify the one or more memory requests to retrieve a contiguous block of several data locations in memory (i.e., a cache line or a cache block). In such an embodiment, the processor originally requests only a portion of said cache line. The caches that lie between the processor and the at least one memory subsystem contain a series of miss status holding registers (MSHRs) which consolidate multiple memory requests to the same cache line into a single memory request by preventing subsequent memory requests to the same cache line (i.e., secondary misses) from continuing on to caches or memory subsystems that lie further from the processor, while the first memory request to that cache line (i.e., a primary miss) continues on. Such an embodiment would consolidate the characterizations of the memory instructions corresponding to the secondary misses with the characterization of the memory instruction corresponding to the primary miss. As the primary miss memory request actually represents all of the secondary misses as well when it reaches the memory scheduler, this consolidation allows for a characterization associated with all of the secondary requests to reach the memory subsystem. In at least one such embodiment of the characterization consolidation, when the primary miss retrieves the cache line, the caches lying between the processor and the at least one memory subsystem will look up the corresponding MSHR entry and resolve each of the primary and secondary misses associated with that entry by providing their requested data. At this time, the data for the primary miss can be annotated with a consolidated characterization. For example, in at least one such embodiment where characterization logic tracks whether a memory instruction remains at the head of the instruction reorder buffer, a consolidated characterization would indicate whether any of the instructions associated with all of the primary or secondary misses for a single MSHR entry remained at the head of the instruction reorder buffer. Another example embodiment provides a consolidated characterization that indicates the total number of instructions associated with all of the primary or secondary misses for a single MSHR entry which remain at the head of the instruction reorder buffer. In these and other example embodiments with this optional consolidation which contain a hardware storage, this hardware storage would be updated according to this consolidated characterization annotated with the data which the primary miss returns to the processor.

A memory scheduler chooses one or more of the pending memory requests to send to the memory subsystem. In one embodiment, the magnitude of the annotation is used to determine the precedence of memory request selection. The memory scheduler identifies a subset of the memory requests that can be sent during the current scheduling interval to the memory subsystem. From this subset, a further subset of memory requests may be identified, where all members of the subset have the greatest magnitude for their annotation—this is inclusive of the case where all pending memory requests have an annotation of zero, i.e. are non-critical. From this subset, the oldest of the requests is selected to be sent to the memory subsystem.

It is contemplated that the logic can be implemented as a series of comparisons using a single binary number that denotes the precedence of the load. For each request, the most significant bit of this precedence value is set to a one if the instruction can be scheduled this interval, and to a zero if it cannot. The next most significant bits contain the annotation. The least significant bits represent the relative age of the request, where an older request has a larger number. Once this precedence value has been generated for all loads under consideration, a comparator tree is used to identify the load with the greatest precedence value. If this load can be scheduled during the current interval, it is then sent to the memory subsystem; otherwise, no request is sent.

In another embodiment, the memory scheduler is a modification of the FR-FCFS scheduler. Within the DRAM memory subsystem, memory is typically organized into at least one DRAM bank, where each bank contains at least one row of memory. Each bank also maintains at least one row buffer, which is used to transfer data between the DRAM bank and components outside of the memory subsystem. The at least one row buffer can only keep open a subset of the rows within the DRAM bank. If a request requires a DRAM bank row that is not currently within a row buffer, the request must be activated such as moved into a row buffer corresponding to the same DRAM bank. If there are no empty row buffers available, the content of one row buffer must be written back to the DRAM bank (i.e., precharged) before the requested row can be activated. As this precharging and activation operations are time consuming, requests sent to rows that are already open can be serviced more rapidly. The FR-FCFS scheduler prefers such requests over ones that require precharging and/or activation, with the aim of reducing the total amount of time required to service all memory requests by reducing the total number of precharge and activate actions taken.

Again, the memory scheduler chooses one or more of the pending memory requests to send to the memory subsystem. It is contemplated that the magnitude of the annotation may be used to determine the precedence of memory request selection. The memory scheduler identifies a subset of the memory requests that can be sent during the current scheduling interval to the memory subsystem. From this subset, a further subset of memory requests may be identified, where all members of the subset are to an open row within a DRAM bank. If there are no requests to an open row, the subset may instead contain all loads that can be sent during the current scheduling interval. From this subset, a further subset of memory requests is identified, where all members of the subset have the greatest magnitude for their annotation—this is inclusive of the case where all pending memory requests have an annotation of zero, i.e. are non-critical. From this subset, the oldest of the requests is selected to be sent to the memory subsystem.

In one embodiment, this logic can be implemented as a series of comparisons using a single binary number that denotes the precedence of the load. For each request, the most significant bit of this precedence value is set to a one if the instruction can be scheduled this interval, and to a zero if it cannot. The next most significant bit is set to a one if the request is to an open row, and to a zero otherwise. The next most significant bits contain the annotation. The least significant bits represent the relative age of the request, where an older request has a larger number. Once this precedence value has been generated for all loads under consideration, a comparator tree can be used to identify the load with the greatest precedence value. If this load can be scheduled during the current interval, it is then sent to the memory subsystem; otherwise, no request is sent.

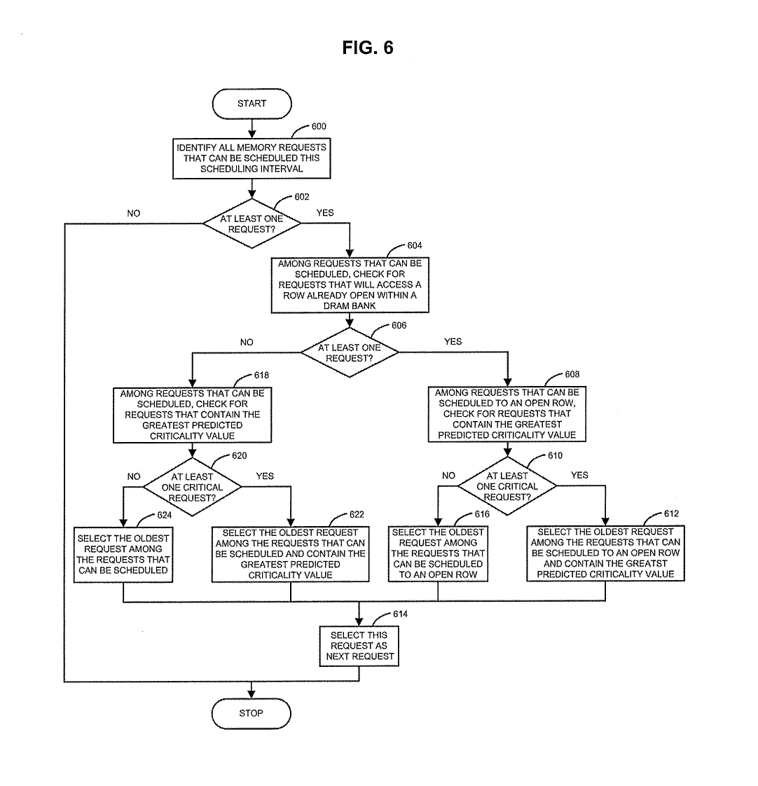

FIG. 6 illustrates a flowchart of an exemplary system that uses annotated prediction within a memory request according to one embodiment of the invention. In order to select which request should be issued to the memory subsystem 130, the memory scheduler 124 uses the algorithm shown in FIG. 6, which is a modification of the First-Ready, First-Come First-Serve (FR-FCFS) memory scheduling algorithm. The memory scheduler 124 analyzes a plurality of the requests stored within the request buffer 122 at every scheduling interval, and determines if at least one of these requests is sent to the memory subsystem 130 during the interval. At 600, the memory scheduler 124 identifies the subset of the requests under consideration that can be scheduled (e.g., the request is valid, the request is to a DRAM bank that is ready to accept requests). If at least one request can be scheduled, flow is from 602 to 604, where the memory scheduler 124 checks this subset of requests that can be scheduled to identify a subset of requests that accesses a memory row that is already open within its corresponding DRAM bank. If this subset of requests to open rows is not empty, flow is from 606 to 608, during which the memory scheduler 124 identifies a further subset of these requests that are predicted as critical and contain the greatest predicted value of criticality. If this further subset is not empty, flow is from 610 to 612, at which point the oldest request within this subset is selected. At 614, this request is selected as the next request 144 to send to the memory subsystem 130. Alternatively, if the subset at 608 is empty, flow is from 610 to 616, at which point the oldest request from the subset of requests to open rows that can be scheduled is selected, and at 614, this request is selected as the next request 144 to send to the memory subsystem 130.

Alternatively, if the subset at 604 is empty, flow is from 606 to 618, at which point the memory scheduler 124 will identify a subset of the requests that can be scheduled which are predicted as critical and contain the greatest predicted value of criticality. If this subset is not empty, flow is from 620 to 622, at which point the oldest request within this subset is selected. At 614, this request is selected as the next request 144 to send to the memory subsystem 130. Alternatively, if the subset at 618 is empty, flow is from 620 to 624, at which point the oldest request from the subset of requests to open rows that can be scheduled is selected, and at 614, this request is selected as the next request 144 to send to the memory subsystem 130.

In another embodiment, the memory scheduler consists of a reinforcement learning based memory scheduler. For every memory request, the scheduler reads in a discrete number of predetermined attributes about the memory request and the memory subsystem. Using a reinforcement learning algorithm adapted for implementation in hardware, the scheduler determines the magnitude of long-term reward for each request based on these attributes. The request with the greatest long-term reward is sent to the memory subsystem.

It is contemplated that the reinforcement learning based memory scheduler includes at least one attribute based on the one or more annotations of the memory request—e.g., the magnitude of the annotation, whether the annotation is non-zero, some classification logic that uses the annotation to divide the requests into discrete groups. When trained using this set of attributes that includes those from the one or more annotations, the reinforcement learning algorithm synthesizes the relationship between the values of the request annotations and their impact on the long-term goals of processor execution such as how quickly a program executes, or how energy efficient the execution is.

In another embodiment of the memory scheduler, requests are assigned to groups. For example, one grouping may be based on which of the processor the request comes from, or from which bank the request wants to access. When none of the requests contain a prioritized annotation, requests are scheduled by sequencing through the groups in a predetermined order. When a request group is selected, a fixed number of requests are scheduled before the scheduler moves onto the next group in order. It is contemplated that when a memory request with a prioritized annotation arrives—regardless of whether the request belongs to the currently-selected group—it is scheduled first. It is also contemplated that if multiple requests with prioritized annotation arrive, the requests may be scheduled in the order in which they arrive; alternatively, the requests with the greatest magnitude of annotation are scheduled first.

In another embodiment, this logic may be implemented using a series of memory requests queues, with one queue per group, as well as an additional queue for prioritized requests. Any request with a non-priority annotation may be sent to the appropriate queue for its group as determined by characterization logic, while requests with prioritized annotations enter the priority queue. The scheduler always checks the priority queue first, and schedules requests from there if the priority queue is not empty. Otherwise, the scheduler schedules a request from the queue corresponding to the currently selected group. If no requests exist within the currently selected group, the scheduler may optionally schedule requests from the next group in order. After a fixed number of scheduling intervals, the current group selection advances to the next group in order.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

1. A system for memory scheduling comprising:
at least one processor for issuing one or more memory requests and processing one or more memory instructions, each memory request corresponding to at least one corresponding memory instruction;
a characterization logic for monitoring the one or more memory instructions and conducting a classification for each memory instruction, the classification for each memory instruction including a discrete number of classes, each memory request including one or more annotations concerning the classification for the at least one corresponding memory instruction by the characterization logic;
at least one memory subsystem for processing the one or more memory requests when the one or more memory requests cannot be resolved by caches that lie logically between the at least one processor and the at least one memory subsystem; and
at least one memory scheduler, wherein the at least one memory scheduler uses the one or more annotations to compel a timing and an order to process the one or more memory requests by the at least one memory subsystem.

2. The system for memory scheduling according to claim 1, further comprising:
a hardware storage for saving information related to the classification conducted by the characterization logic to obtain saved information.

3. The system for memory scheduling according to claim 2, wherein the saved information assists the characterization logic.

4. The system for memory scheduling according to claim 1, wherein the classification for each memory instruction is based on a relative urgency of processing by the at least one memory subsystem the one or more memory requests.

5. The system for memory scheduling according to claim 3, wherein the classification for each memory instruction is based on the relative urgency of processing by the at least one memory subsystem the one or more memory requests.

6. The system for memory scheduling according to claim 1, further comprising an instruction reorder buffer.

7. The system for memory scheduling according to claim 6, wherein the classification for each memory instruction includes one or more selected from the group consisting of: a frequency and an amount of time by which each memory instruction remains at a head of the instruction reorder buffer.

8. The system for memory scheduling according to claim 3, further comprising an instruction reorder buffer.

9. The system for memory scheduling according to claim 8, wherein the classification for each memory instruction includes one or more selected from the group consisting of: a frequency and an amount of time by which each memory instruction remains at a head of the instruction reorder buffer.

10. A method for memory scheduling comprising the steps of:
issuing by a processor one or more memory requests;
processing by the processor one or more memory instructions, wherein one memory request corresponds to at least one corresponding memory instruction;
monitoring by a characterization logic the one or more memory instructions;
conducting by the characterization logic a classification for each memory instruction, the classification including a discrete number of classes;
annotating by the characterization logic each memory request to include the classification for the at least one corresponding memory instructions;
determining by a memory scheduler a time and an order for processing the one or more memory requests by the memory subsystem influenced by the classification;
processing by the memory subsystem the one or more memory requests according to the time and the order determined by the memory scheduler; and
processing by the memory subsystem the one or more memory requests when the one or more memory requests could not be resolved by caches that lie logically between the at least one processor and the memory subsystem.

11. The method for memory scheduling according to claim 10, further comprising the step of:
saving by a hardware storage information related to the classification conducted by the characterization logic.

12. The method for memory scheduling according to claim 11, further comprising the step of:
using the information to assist the characterization logic.

13. The method for memory scheduling according to claim 10, wherein the classification for each memory instruction is based on a relative urgency of processing by the memory subsystem the one or more memory requests.

14. The method for memory scheduling according to claim 12, wherein the classification for each memory instruction is based on a relative urgency of processing by the memory subsystem the one or more memory requests.

15. The method for memory scheduling according to claim 10, wherein the classification for each memory instruction includes one or more selected from the group consisting of: a frequency and an amount of time by which each memory instruction remains at a head of an instruction reorder buffer.

16. The method for memory scheduling according to claim 12, wherein the classification for each memory instruction includes one or more selected from the group consisting of: a frequency and an amount of time by which each memory instruction remains at a head of an instruction reorder buffer.
